(19) United States
(12) Patent Application Publication
(10) Pub. No.: US 2020/0007707 A1
(43) Pub. Date: Jan. 2, 2020

(54) LENS MIRROR ARRAY AND IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Takashi SHIRAISHI, Kawasaki Kanagawa (JP)

(21) Appl. No.: 16/570,596

(22) Filed: Sep. 13, 2019

Related U.S. Application Data
(63) Continuation of application No. 15/885,130, filed on Jan. 31, 2018.

(30) Foreign Application Priority Data
Aug. 9, 2017 (JP) 2017-154663

(51) Int. Cl. H04N 1/193; H04N 1/10; H04N 1/031; H04N 1/028

(52) U.S. Cl. CPC H04N 1/1937; H04N 1/0289; H04N 1/0318; H04N 1/1039

(57) ABSTRACT

In accordance with an embodiment, a lens mirror array includes a plurality of optical elements integrally connected in a first direction. Each optical element includes an incident side lens surface through which light enters the optical element, a ridge located at an edge of the incident side lens surface, a reflection surface on which light incident on the incident side lens surface is reflected, an exit side lens surface through which light reflected by the reflection surface exits the optical element, and a groove surrounding the reflection surface except for a portion adjacent to the ridge, the portion adjacent to the ridge connecting to an adjacent optical element in the plurality of optical elements.

### CROSS-REFERENCE TO RELATED APPLICATION(S)

This application is a continuation of U.S. patent application Ser. No. 15/885,130, filed Jan. 31, 2018, which application is based upon and claims the benefit of priority from Japanese Patent Application No. 2017-154663, filed Aug. 9, 2017, the entire contents of which are incorporated herein by reference.

### FIELD

Embodiments described herein relate generally to a lens mirror array incorporated into a document reading device and an exposure device of an image forming apparatus such as a copying machine, a multifunctional peripheral, a printer or a scanner, and the image forming apparatus using the same.

### BACKGROUND

In an exposure device of an image forming apparatus, which forms an electrostatic latent image on a surface of a photoconductive drum, a lens mirror array refracts and reflects light based on an image signal incident from the light source and focuses the light onto the surface of the photoconductive drum. The lens mirror array includes optical elements that focus the light from light sources arranged along a main scanning direction onto the surface of the photoconductive drum. The lens mirror array can be formed as integrated unit with the optical elements and is made of, for example, a transparent resin.

A light shielding material is applied to the surface of each optical element for reducing stray light, for example, light incident on the optical element from an adjacent optical element.

However, the light shielding material also decreases the efficiency of the optical components. Also, the properties of the light shielding material may vary component to component.

In some applications that are relatively tolerant of stray light, a light shielding material may not be required on the optical elements. However, in such case, the thickness difference of the incident lens surfaces among a plurality of optical elements becomes large and it is difficult to uniformly mold the optical elements with precision and the imaging characteristics may become deteriorated.

### DESCRIPTION OF THE DRAWINGS

FIG. 1 is a schematic diagram of a copying machine according to an embodiment.

FIG. 2 is a schematic diagram of a document reading device.

FIG. 3 is a schematic diagram of an exposure device.

FIG. 4 is an external perspective view of a lens mirror array.

FIG. 5 is an enlarged external perspective view of a lens mirror array.

FIG. 6 is a cross-sectional view of a lens mirror array taken along line F6-F6 in FIG. 5 according to a first embodiment.

FIG. 7 is a cross-sectional view of a lens mirror array taken along line F6-F6 in FIG. 5 according to a second embodiment.

FIG. 8 is a cross-sectional view of a lens mirror array taken along line F6-F6 in FIG. 5 according to a third embodiment.

FIG. 9 is an enlarged external perspective view of a conventional lens mirror array.

FIG. 10 is a schematic diagram of an image forming apparatus including a lens mirror array according to the second embodiment.

### DETAILED DESCRIPTION

In accordance with an embodiment, a lens mirror array includes a plurality of optical elements integrally connected in a first direction. Each optical element includes an incident side lens surface through which light enters the optical element, a ridge located at an edge of the incident side lens surface, a reflection surface on which light incident on the incident side lens surface is reflected, an exit side lens surface through which light reflected by the reflection surface exits the optical element, and a groove surrounding the reflection surface except for a portion adjacent to the ridge, the portion adjacent to the ridge connecting to an adjacent optical element in the plurality of optical elements.

Hereinafter, image forming apparatuses according to example embodiments will be described with reference to the accompanying drawings. It should be noted that the particular embodiments explained below are some possible example of an image forming apparatus according to the present disclosure and do not limit the possible configuration, specifications, or the like of image forming apparatuses according to the present disclosure.

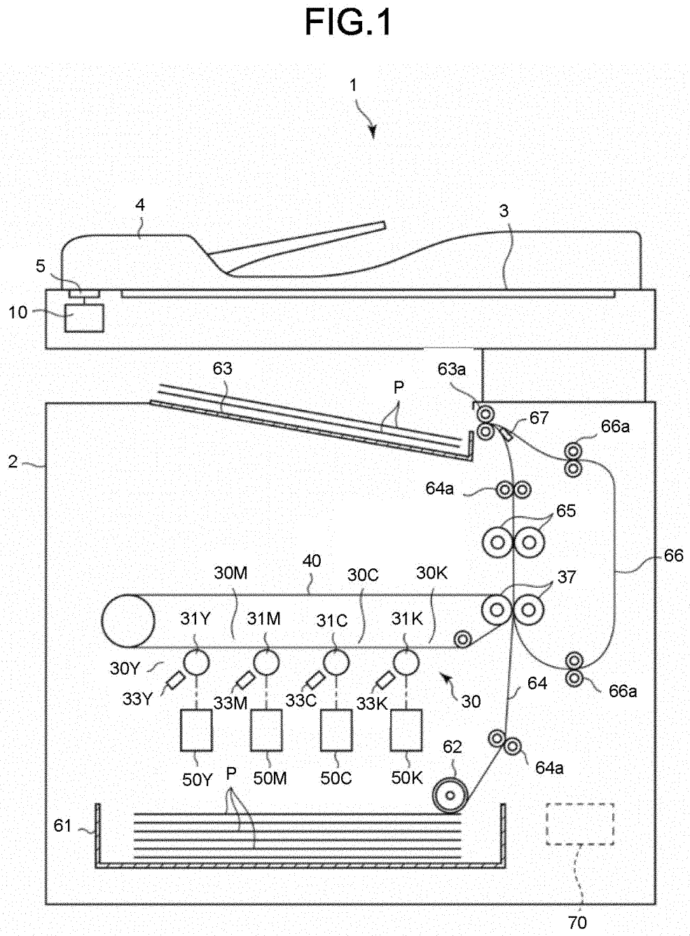

FIG. 1 is a schematic diagram of a copying machine 1 according to an embodiment. The copying machine 1 is described as an example of an image forming apparatus. The copying machine 1 is, for example, a solid-state scanning system LED copying machine having an exposure optical system using a semiconductor light emitting diode element as a light source.

The copying machine 1 has a housing 2. A transparent document table glass 3 on which a document can be placed. The document table glass 3 is arranged on the upper surface of the housing 2. On the document table glass 3, an automatic document feeder (ADF) 4 is arranged. The ADF 4 can be open and closed. The ADF 4 holds the document on the document table glass 3 in place and also feeds a document through a reading glass 5.

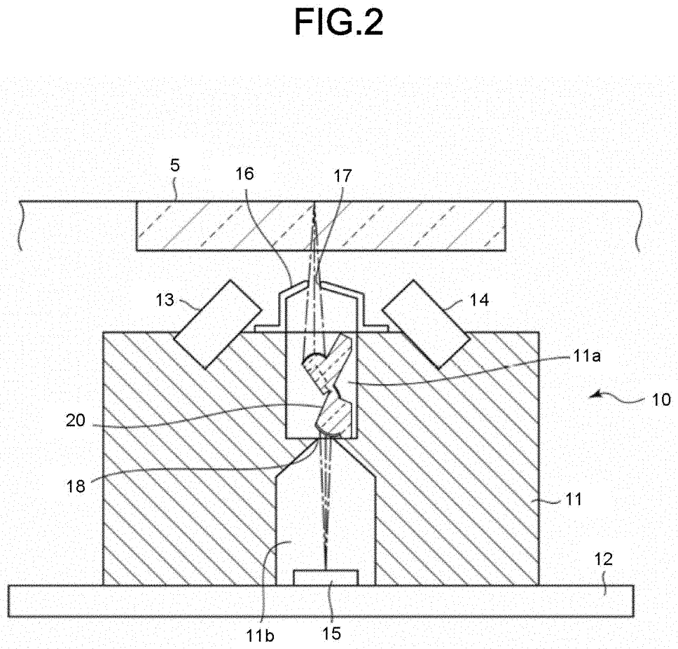

Below the document table glass 3, a document reading device 10 is provided. FIG. 2 is a schematic diagram of the document reading device 10. The document reading device 10 can move in a horizontal, page left-page right direction in FIG. 1 (also referred to as a sub-scanning direction) on the document table glass 3 by a driving mechanism (not shown), and can be fixed below the transparent reading glass 5 (shown in FIG. 1) in plane with the document table glass 3.

As shown in FIG. 2, the document reading device 10 has a support body 11 having a rectangular block shape. The support body 11 extends in a main scanning direction that is orthogonal to the sub-scanning direction and parallel to a rotation axis of a photoconductive drum. The support body 11 is arranged on a base plate 12. The base plate 12 extends in the main scanning direction. The base plate 12 and the support body 11 are provided to be movable in the sub-scanning direction along the document table glass 3.

On an upper surface of the support body 11 on the reading glass 5 side, two illuminating devices 13 and 14 are provided. The illuminating devices 13 and 14 extend in the main scanning direction and are separated from each other in the horizontal direction (page left-page right direction) in FIG. 2 along the sub-scanning direction. The illuminating devices 13 and 14 move in the sub-scanning direction together with the support body 11, illuminate the document on the document table glass 3, and document fed along the reading glass 5 through the reading glass 5. The illuminating devices 13 and 14 are inclined with respect to the support body 11 in which the illuminated light directs towards a reading area of the document.

The illuminating devices 13 and 14 each include, for example, a light source including a plurality of LED elements (not specifically depicted) arranged in the main scanning direction, and a light guide (not specifically depicted) extending in the main scanning direction. In other embodiments, the illuminating devices 13 and 14 each can be a fluorescent tube, a xenon tube, a cold cathode ray tube, an organic EL device or the like.

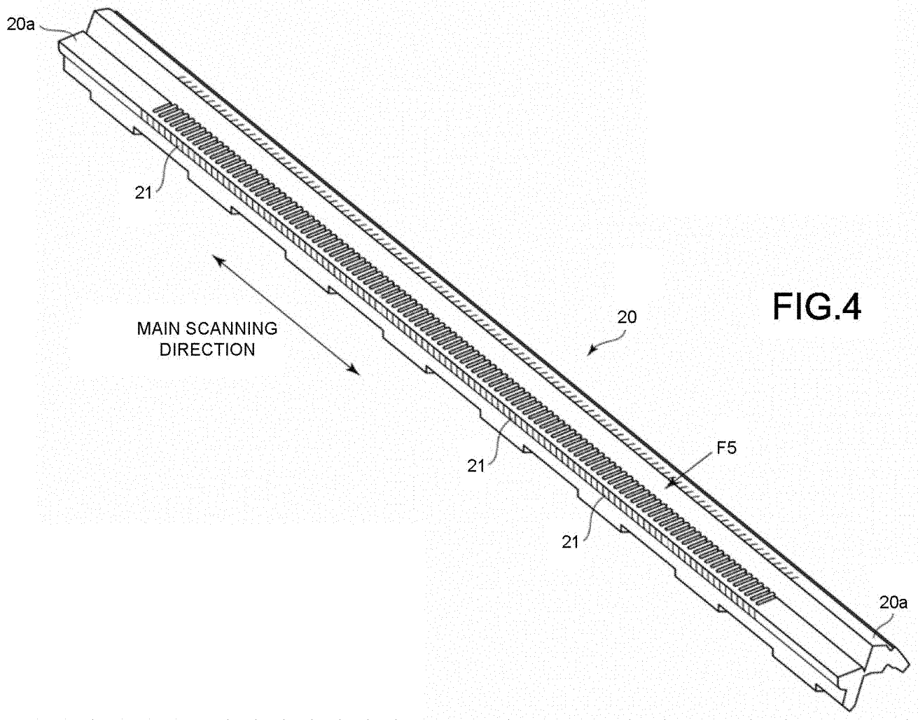

A lens mirror array 20 is provided in the support body 11 near the upper surface between the two illuminating devices 13 and 14. FIG. 4 shows an external perspective view of the lens mirror array 20. The lens mirror array 20 extends in the main scanning direction and forms an erect image of the document on an image sensor 15 (also referred to as a photoelectric conversion section) on the base plate 12.

The image sensor 15 is a line sensor having a plurality of image capturing elements which convert an incident light to an electric signal (also referred to as an image signal) arranged in a line along the main scanning direction. The image sensor 15 includes, for example, a CCD (Charge Coupled Device), a CMOS (Complementary Metal Oxide Semiconductor), or other image capturing elements.

On the upper surface of the support body 11, a light shielding member 16 is attached. The light shielding member 16 has a slit 17 extending in the main scanning direction and the reflected light from the document passing through the slit 17 is directed to the lens mirror array 20. The light shielding member 16 is rectangular extending along the main scanning direction and bent along a longitudinal direction. A light shielding material is applied to the surface of the light shielding member 16. The slit 17 of the light shielding member 16 blocks light reflected light from outside of a predetermined range of the document from being incident on the lens mirror array 20.

The support body 11 has a slit 18 extending in the main scanning direction on the image sensor 15 side of the lens mirror array 20. The support body 11 has a room 11a which accommodates the lens mirror array 20 and a room 11b which accommodates the image sensor 15, and the slit 18 is between the rooms 11a and 11b. The slit 18 has a width that allows the reflected light from the document to pass through from light emitted from the lens mirror array 20 and blocks the stray light at an edge of the slit 18.

For example, if the document is fed by the ADF 4 when the document reading device 10 is located under the reading glass 5 as shown in FIGS. 1 and 2, the illuminating devices 13 and 14 illuminate the document through the reading glass 5. The reflected light from the document is incident on the lens mirror array 20 via the slit 17 of the light shielding member 16. The lens mirror array 20 reflects and focuses the reflected light from the document and emits the focused light towards the image sensor 15 via the slit 18. The image sensor 15 receives the reflected light from the document, performs photoelectrical conversion on the reflected light, and outputs an image signal.

When the ADF 4 conveys the document through the reading glass 5 in the sub-scanning direction, an image of the document formed on the image sensor 15 is read for each of multiple lines into which the document is divided along the main scanning direction, and thus an entire image of the document can be obtained. Alternatively, an entire image of the document can be obtained when the document reading device 10 moves along the document table glass 3 in the sub-scanning direction and an image of the document formed on the image sensor 15 can be read for each line of the document.

The copying machine 1 has an image forming section 30 substantially at the center in the housing 2. The image forming section 30 has a yellow image forming section 30Y, a magenta image forming section 30M, a cyan image forming section 30C, and a black image forming section 30K along a transfer direction of an intermediate transfer belt 40. Each of the image forming sections 30Y, 30M, 30C and 30K is similarly formed. In the following descriptions, the black image forming section 30K will be described as an example and the other colors (Y, M, C) will not be separately described.

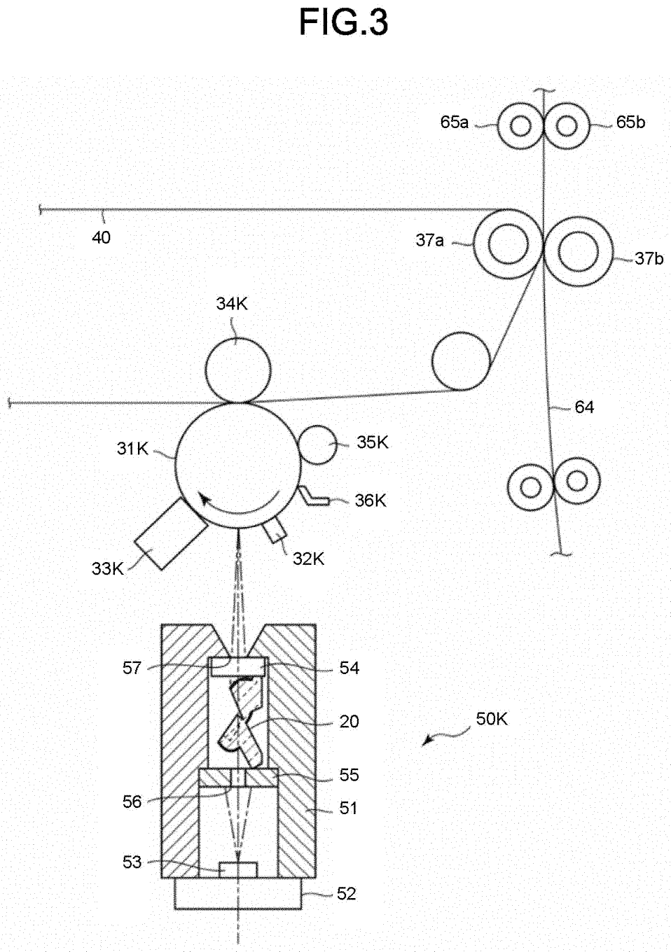

FIG. 3 is an enlarged schematic view of the black image forming section 30K. The black image forming section 30K includes, for example, a photoconductive drum 31K (also referred to as a photoconductor), an electrostatic charger 32K, an exposure device 50K, a developing device 33K, a primary transfer roller 34K, a cleaner 35K and a blade 36K.

The photoconductive drum 31K has a rotation axis extending in the main scanning direction and an outer circumferential surface of the photoconductive drum 31K is in contact with the surface of the intermediate transfer belt 40 while the photoconductive drum 31K rotates around the rotation axis. Inside of the intermediate transfer belt 40 facing the photoconductive drum 31K, a primary transfer roller 34K is provided. The photoconductive drum 31K is rotated in a clockwise direction indicated by the arrow in FIG. 3 at the same peripheral speed as the intermediate transfer belt 40 by a driving mechanism (not shown).

The electrostatic charger 32K uniformly charges the surface of the photoconductive drum 31K. The exposure device 50K irradiates the surface of the photoconductive drum 31K with exposure light based on a portion of an image signal color separated for black (also referred to simply as a black portion of an image signal or a black image portion hereinafter), and forms an electrostatic latent image based on the black image portion on the surface of the photoconductive drum 31K. The developing device 33K supplies black toner for the electrostatic latent image formed on the surface of the photoconductive drum 31K to form a black toner image on the surface of the photoconductive drum 31K.

The primary transfer roller 34K transfers the black toner image formed on the surface of the photoconductive drum 31K and toner images of other colors onto the intermediate transfer belt 40. The cleaner 35K and the blade 36K remove the toner remaining on the surface of the photoconductive drum 31K. The toner images of all colors on the surface of the intermediate transfer belt 40 are conveyed by the intermediate transfer belt 40 and inserted between secondary transfer rollers 37a and 37b, which may be collectively referred to as a transfer roller pair 37.

As shown in FIG. 3, the exposure device 50K has a support body 51 in a rectangular block shape. The support body 51 extends in the main scanning direction parallel to the rotation axis of the photoconductive drum 31K and is spaced away from the photoconductive drum 31K below the photoconductive drum 31K.

The support body 51 supports a lens mirror array 20 having the same structure as the lens mirror array 20 of the document reading device 10 with the orientation thereof reversed. The lens mirror array 20 extends in the main scanning direction and reflects and focuses the light emitted from a light source 53, and emits the focused light towards the surface of the photoconductive drum 31K. The light source 53 includes a plurality of light emitting elements in a line along the main scanning direction on the surface of a base plate 52. The light sources 53 are provided in one or a plurality of lines.

The light source 53 emits the light based on the portion of the image signal color separated for black (also referred as image data) acquired by the document reading device 10 and image data acquired via an external device such as a personal computer (not shown). The plurality of light emitting elements of the light source 53 is, for example, LEDs or OLEDs that turn on or off based on the image data.

The support body 51 supports a transparent protective glass 54 on the photoconductive drum 31K side of the lens mirror array 20. The protective glass 54 prevents toner and dust from adhering to the lens mirror array 20. The protective glass 54 abuts against one end of the lens mirror array 20. The support body 51 supports a light shielding body 55 on the light source 53 side of the lens mirror array 20. The light shielding body 55 has a slit 56 extending in the main scanning direction. A light shielding material is applied to the surface of the light shielding body 55. The light shielding body 55 shields some of the light emitted from the light source 53.

The support body 51 has a slit 57 extending in the main scanning direction at the exit side of the light of the protective glass 54. The slit 57 has a width that selectively allows a light component necessary for the exposure to pass through and shields stray light unnecessary for the exposure at the edge of the slit 57.

The light emitted from the light source 53 passes through the slit 56 and is incident on the lens mirror array 20. The lens mirror array 20 reflects and focuses the light from the light source 53. The light emitted from the lens mirror array 20 is focused on the surface of the rotating photoconductive drum 31K via the protective glass 54 and the slit 57.

An electrostatic latent image is formed one line at a time along the main scanning direction on the surface of the photoconductive drum 31K by rotation of the photoconductive drum 31K. When the photoconductive drum 31K rotates by a certain amount, an electrostatic latent image corresponding to the black image portion is formed on the surface of the photoconductive drum 31K.

As shown in FIG. 1, the copying machine 1 has a transfer roller pair 37 for transferring toner images of all colors onto the surface of the intermediate transfer belt 40 as a sheet P is being conveyed between the transfer roller pair 37. As shown in FIG. 3, the intermediate transfer belt 40 is formed in a loop, and one transfer roller 37a is arranged inside the loop. The other transfer roller 37b is arranged outside of the loop on the other side from the transfer roller 37a and faces the transfer roller 37a. The toner images of all colors transferred onto the surface of the intermediate transfer belt 40 are fed to a nip of the transfer roller pair 37 by the intermediate transfer belt 40.

Near the inner lower end of the housing 2, a sheet feed cassette 61 accommodating a stack of sheets P of a predetermined size. The sheet feed cassette 61 is arranged such that a sheet can be load and unload from the front surface of the housing 2. A pickup roller 62 for taking a topmost sheet P of the stack of sheets P is arranged above the right end of the sheet feed cassette 61 in FIG. 1. The pickup roller 62 takes out the sheets P one by one by rotating with the peripheral surface of the pickup roller 62 in contact with the sheet P.

A sheet discharge tray 63 is provided at the inner upper part of the housing 2. The sheet discharge tray 63 is arranged below the document table glass 3 and discharges the sheet P on which an image is formed. The sheet P taken out from the sheet feed cassette 61 is conveyed on a conveyance path 64 from the pickup roller 62 towards the sheet discharge tray 63 in a vertical direction. The conveyance path 64 extends through the nip of the transfer roller pair 37 and includes a plurality of conveyance roller pairs 64a and a conveyance guide (not shown). At the end of the conveyance path 64, a sheet discharge roller pair 63a for discharging the sheet P to the sheet discharge tray 63 is arranged. The sheet discharge roller pair 63a can rotate in both forward and reverse directions.

On the conveyance path 64 at the downstream side of the transfer roller pair 37, a fixing roller pair 65 is arranged. The fixing roller pair 65 heats and pressurizes the sheet P conveyed via the conveyance path 64 to fix the toner image transferred onto the surface of the sheet P.

The copying machine 1 has an inverse conveyance path 66 for inverting the front and back surfaces of the sheet P with an image formed on one surface thereof and sending the sheet P to the nip of the transfer roller pair 37. The inverse conveyance path 66 has a plurality of conveyance roller pairs 66a rotating to convey the sheet P while sandwiching the sheet P therebetween and a conveyance guide (not shown). At the upstream side of the sheet discharge roller pair 63a, a gate 67 for switching a conveyance destination of the sheet P between the conveyance path 64 and the inverse conveyance path 66 is arranged.

When the pickup roller 62 is rotated to take out the sheet P from the sheet feed cassette 61, the sheet P is conveyed by the plurality of the conveyance roller pairs 64a towards the sheet discharge tray 63 via the conveyance path 64. During the conveyance, the toner images of all colors on the surface of the intermediate transfer belt 40 are sent to the nip of the transfer roller pair 37 in accordance with a conveyance timing of the sheet P, and the toner images of all colors are transferred onto the surface of the sheet P when a transfer voltage is applied from the transfer roller pair 37.

The sheet P onto which the toner image is to be transferred is heated and pressurized while passing through the fixing roller pair 65, the toner image is melted and pressed on the surface of the sheet P, and the toner image is fixed on the sheet P. The sheet P on which the image has been formed is discharged to the sheet discharge tray 63 via the sheet discharge roller pair 63a.

When a double-sided mode, in which an image is to be formed also on the back surface of the sheet P, is selected, immediately before a rear end of the sheet P in a discharge direction leaves the nip of the discharge roller pair 63a, the gate 67 switches the conveyance direction to the inverse conveyance path 66, and the sheet discharge roller pair 63a is rotated reversely. As a result, the rear end of the sheet P is directed to the inverse conveyance path 66, the front and back surfaces the sheet P are reversed and the sheet P is sent to the nip of the transfer roller pair 37.

The toner image is formed on the surface of the intermediate transfer belt 40 based on the image data to be formed on the back surface of the sheet P, and while the intermediate transfer belt 40 holds the toner images of all colors, the toner images of all colors are sent to the nip of the transfer roller pair 37. The toner image is transferred and fixed on the back surface of the inverted sheet P, and the sheet P is discharged to the sheet discharge tray 63 via the sheet discharge roller pair 63a.

The copying machine 1 has a controller 70 which controls the above-described operations. The controller 70 includes a processor such as a CPU and a memory. The controller 70 realizes various processing functions by executing programs stored in a memory by a processor. The controller 70 acquires an image data of the document from the document reading device 10. The controller 70 controls the image forming section 30 to form an image on the surface of the sheet P. Specifically, the controller 70 inputs the image data read by the document reading device 10 to the image forming section 30. The controller 70 controls the operations of a plurality of the conveyance roller pairs 64a and 66a to convey the sheet P through the conveyance path 64 and the inverse conveyance path 66.

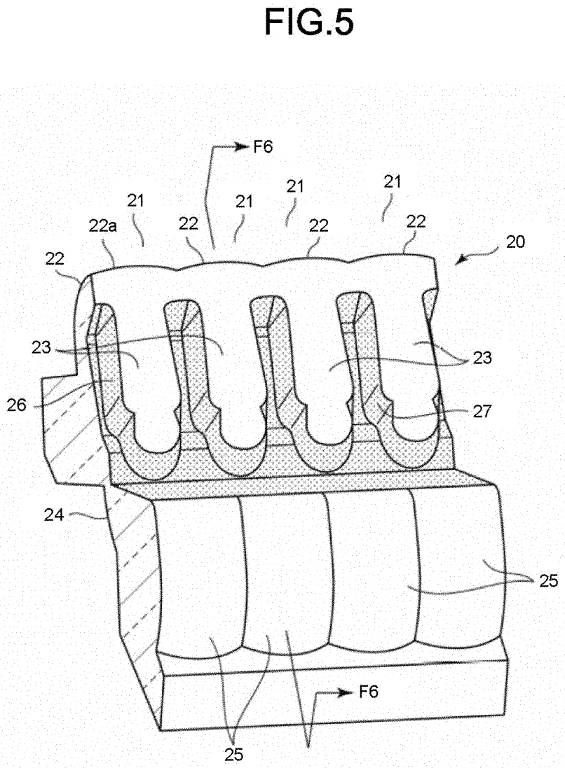

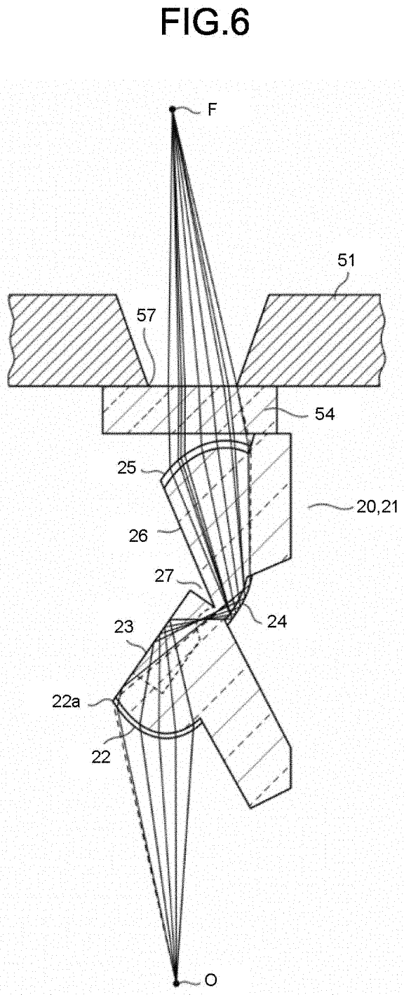

The lens mirror array 20 is described below with reference to FIG. 4 to FIG. 6. FIG. 4 is an external perspective view of the lens mirror array 20. FIG. 5 is an enlarged external perspective view of the lens mirror array 20. FIG. 6 is a cross-sectional view taken along line F6-F6 of the lens mirror array 20 according to a first embodiment. In FIG. 6, a locus of the incident light on the lens mirror array 20 from an object point O and converges to an image forming point F is shown as a ray diagram.

In FIG. 2, the lens mirror array 20 is incorporated in the document reading device 10 and extends along the main scanning direction. In FIG. 3, the lens mirror array 20 is incorporated in the exposure devices 50Y, 50M, 50C and 50K and extends along the main scanning direction. The lens mirror array 20 has a structure in which a plurality of transparent optical elements 21 having substantially the same shape is integrally aligned in the main scanning direction. In FIG. 5, only four transparent optical elements 21 are shown, but a number of the transparent optical elements 21 is not limited to four. In addition to the plurality of the optical elements 21, the lens mirror array 20 has extension portions 20a at both ends in the longitudinal direction thereof by which a user can handle the lens mirror array 20. In the present embodiment, the lens mirror array 20 is made of integrated molding of transparent resin. The lens mirror array 20 may be made of glass.

As shown in FIG. 6, each of the optical elements 21 focuses diffused light from the object point O to form an image at the image forming point F. The light from a plurality of object points O aligned in the main scanning direction is incident on one optical element 21. For example, the light from the object point O arranged in a width having two to three times of a pitch in the main scanning direction of the optical element 21 is incident on one optical element 21. Each of the optical elements 21 reflects the incident light twice and emits the reflected light to form an erect image of the object point O at the imaging point F.

If the lens mirror array 20 is incorporated in the document reading device 10 shown in FIG. 2, a plurality of the optical elements 21 images the reflected light from the document on a light receiving surface of the image sensor 15. If the lens mirror array 20 is incorporated in the exposure device 50K shown in FIG. 3, a plurality of the optical elements 21 images the light from the light source 53 on the surface of the photoconductive drum 31K.

In the example embodiment described below, the lens mirror array 20 is incorporated in the exposure device 50K.

As shown in FIG. 5 and FIG. 6, the optical element 21 has an incident side lens surface 22 (also referred to as an incidence plane), an upstream side reflection surface 23 (also referred to as a reflection plane or simply as a reflection surface), a downstream side reflection surface 24, and an exit side lens surface 25 (also referred to as an exit plane). The incident side lens surface 22, the downstream side reflection surface 24, and the exit side lens surface 25 are outwardly convex curved surfaces. The upstream side reflection surface 23 is a flat surface. Between the incident side lens surface 22 and the upstream side reflection surface 23, a ridge 22a extending substantially in the main scanning direction is arranged. An imaginary boundary surface between the two optical elements 21 adjacent to each other in the main scanning direction is substantially orthogonal to each of the surfaces 22, 23, 24 and 25.

The surfaces 22, 23, 24 and 25 of the optical element 21 are the surfaces substantially along the longitudinal direction of the lens mirror array 20. Specifically, in the lens mirror array 20 in which a plurality of the optical elements 21 is integrally connected in the main scanning direction, the surfaces 22, 23, 24 and 25 of the individual optical elements 21 are continuous surfaces in the lens mirror array 20 and are respectively connected in the main scanning direction between the individual optical elements 21. The lens mirror array 20 is attached such that the incident side lens surfaces 22 of the plurality of the optical elements 21 are facing the light source 53.

As shown in FIG. 6, if focusing on one optical element 21, the diffused light from the light source 53 placed at the object point O is incident on the incident side lens surface 22. The incident diffused light converges on the incident side lens surface 22 to form an intermediate inverted image thereon. The upstream side reflection surface 23, which is connected to the incident side lens surface 22 via the ridge 22a, reflects the incident light through the incident side lens surface 22 towards the downstream side reflection surface 24 by total internal reflection or Fresnel reflection.

The downstream side reflection surface 24 further reflects the light reflected by the upstream side reflection surface 23 towards the exit side lens surface 25 by the total internal reflection or the Fresnel reflection. The downstream side reflection surface 24 may be formed by a flat surface. The exit side lens surface 25 emits the light reflected by the downstream side reflection surface 24 towards the surface of the photoconductive drum 31K arranged at the imaging point F. The exit side lens surface 25 is combined with the downstream side reflection surface 24 to form an erect image that is an inverted image of the intermediate inverted image formed by the incident side lens surface 22. The light emitted from the exit side lens surface 25 is imaged on the surface of the photoconductive drum 31K arranged at the imaging point F.

A light shielding material 26 is applied to the surface of the optical element 21. The light shielding material 26 is applied to the surface of the optical element 21 by a liquid dispenser, an ink jet head or the like. The portion to which the light shielding material 26 is applied is the shaded portion depicted in FIG. 5. The light shielding material 26 is a highly light-shielding ink, for example, a UV-curable ink containing a light shielding material such as carbon black, pigment or dye, with a polymer having substantially the same refractive index as the lens mirror array 20 as a base material. The light shielding material 26 prevents the light passing through the lens mirror array 20 from being reflected and being emitted to the outside of the lens mirror array 20.

As shown in FIG. 5, each of the upstream side reflection surfaces 23 of the optical elements 21 adjacent to each other in the main scanning direction is formed such that the edges at the ridge 22a side close to the incident side lens surface 22 are flush with each other. Between the upstream side reflection surfaces 23 of the optical elements 21, a pectinate groove 27 divides the reflection plane (upstream side reflection surfaces 23). The groove 27 surrounds an end portion of each upstream side reflection surface 23 that is farthest from the incident side lens surfaces 22 and defines one end of the exit side lens surface 25. The groove 27 surrounds each upstream side reflection surface 23 excepting for a portion adjacent to the ridge 22a. That is, the groove 27 does not reach the ridge 22a and a portion of each upstream side reflection surface 23 remains at the end of the upstream side reflection surface 23 proximate to the ridge 22a. The remaining portions of the upstream side reflection surfaces 23 connect between adjacent optical elements 21.

Then, the light shielding material 26 is applied to the whole surface of the groove 27. For example, the light shielding material 26 is injected into the groove 27 by a dispenser, and is applied to the inner surface of the groove 27 by capillary action and the like. When the light shielding material 26 is applied to the inner surface of the groove 27 in this manner, an appropriate amount of the light shielding material 26 can be continuously and quickly applied, the operation can be simplified and the light shielding material 26 can be uniformly applied to each optical element 21. In the present embodiment, the light shielding material 26 is not applied to the surface of the lens mirror array 20, particularly, the upstream side reflection surface 23, other than within the groove 27.

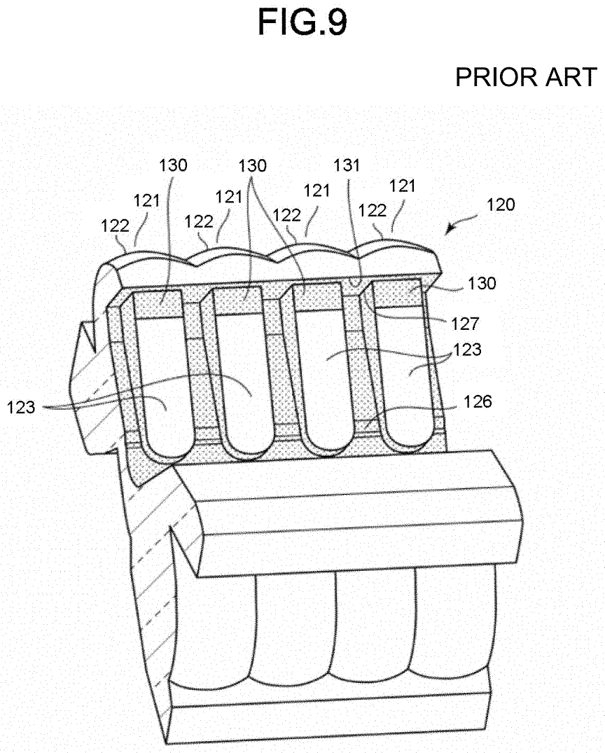

FIG. 9 is an enlarged external perspective view of a conventional lens mirror array 120. The conventional lens mirror array 120 depicted in FIG. 9 can be compared to the lens mirror array 20 depicted in FIG. 5. The conventional lens mirror array 120 has a step 130 at the end close to the incident side lens surface 122 of the upstream side reflection plane 123 of each optical element 121. In the conventional lens mirror array 120, the upstream side reflection planes 123 are not flush with one another. Otherwise, the lens mirror array 20 and the conventional lens mirror array 120 are similar in configuration.

If the light shielding material 126 is applied to the conventional lens mirror array 120 as an initially liquid ink, then the ink flows into the groove 127 by a capillary phenomenon and wets the groove 127. The ink spreads along the step 130. Then, after the ink spreads due to the capillary phenomenon to a vertical wall 131 of the step 130 orthogonal to the upstream side reflection plane 123, it ultimately dries adhered onto these various surfaces. By providing the light shielding material 126 on the vertical wall 131, it is possible to enable the edge at the step 130 side of the upstream side reflection plane 123 to stand out, and this can prevent stray light from being generated.

However, if the light shielding material 126 is applied to the vertical wall 131, the ink undesirably also adheres to a part of the upstream side reflection plane 123 as well. In this case, since areas of the light shielding material 126 partially spreading on the upstream side reflection plane 123 have different sizes for each of the optical elements 121, optical characteristics vary among the optical elements 121. Since the area of the upstream side reflection plane 123 where the light shielding material 126 is applied does not function properly as the reflection plane, light transmission efficiency decreases accordingly.

Therefore, in the present embodiment, as shown in FIG. 5, by connecting the ends close to the incident side lens surfaces 22 of the upstream side reflection planes 123 of the plurality of the optical elements 21 in the same plane without including the step 130, the light shielding material 26 does not spread by capillary phenomenon and thus does not adhere to the upstream side reflection plane 123. In the lens mirror array 20 according to the present embodiment, if the light shielding material 26 flows into the groove 27, and the light shielding material 26 is applied by utilizing capillary action or liquid surface tension, the ink which is the light shielding material 26 does not adhere to the upstream side reflection surface 23.

Therefore, according to the present embodiment, it is possible to prevent variations in the optical characteristics among a plurality of the optical elements 21. According to the present embodiment, it is possible to prevent the light transmission efficiency by the lens mirror array 20 from deteriorating. According to the present embodiment, it is possible to provide the lens mirror array 20 having improved light transmission efficiency and improved optical characteristics without variation among a plurality of the optical elements 21.

In the example embodiment described above, by connecting the ends of the upstream side reflection surfaces 23 of a plurality of the optical elements 21 in the same plane, the optical characteristics of the lens mirror array 20 are improved. However, it is not always necessary to connect a plurality of the upstream side reflection surfaces 23 in the same plane at one ends thereof. For example, a space between the upstream side reflection surfaces 23 adjacent to each other in the main scanning direction may be completely divided by the groove 27. Unless a structure such as the vertical wall 131, in FIG. 9, that is orthogonal to the upstream side reflection surface 23 is provided, the light shielding material 26 does not spread on the upstream side reflection surface 23 by capillary action or the like.

According to the present embodiment, by partially connecting the plurality of the upstream side reflection surfaces 23, an area of the reflection plane can be enlarged, and the light transmission efficiency can be enhanced. By connecting the upstream side reflection surfaces 23 in the same plane in the vicinity of the ridge 22a, the light reflected by the upstream side reflection surface 23 near the ridge 22a between the incident side lens surface 22 and the upstream side reflection surface 23 is transmitted to the surface of the photoconductive drum 31K via the lens mirror array 20.

It is difficult perform the processing for emphasizing the edge on for the ridge 22a, and R is easily attached. A burr due to injection molding is easy to occur at the ridge 22a. For this reason, the light reflected by the upstream side reflection surface 23 near the ridge 22a is reflected in all directions, which tends to be the noise component and the stray light. In the present embodiment, the slit 57 shields the stray light, indicated by a broken line in FIG. 6, so that the light does not reach the surface of the photoconductive drum 31K.

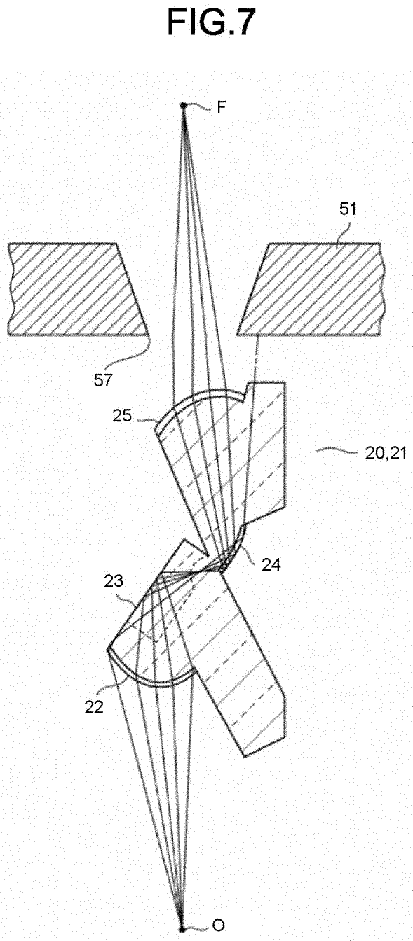

FIG. 7 is a cross-sectional view of the lens mirror array according to a second embodiment. In FIG. 7, the stray light reflected by the upstream side reflection surface 23 is shielded near the ridge 22a.

In the second embodiment, the shape of the exit side lens surface 25 of the lens mirror array 20 is modified so that the stray light reflected near the ridge 22a does not pass through the exit side lens surface 25. The edge of the exit side lens surface 25 of the lens mirror array 20 is moved slightly inward to reduce the area of the exit side lens surface 25, and the stray light passes through other parts deviating from the exit side lens surface 25. The other parts function as a bifurcation module that bifurcates the stray light reflected near the ridge 22a from other effective light which is emitted through the exit side lens surface 25. The bifurcated light beam is shielded by the support body 51 at a position far away from the effective light.

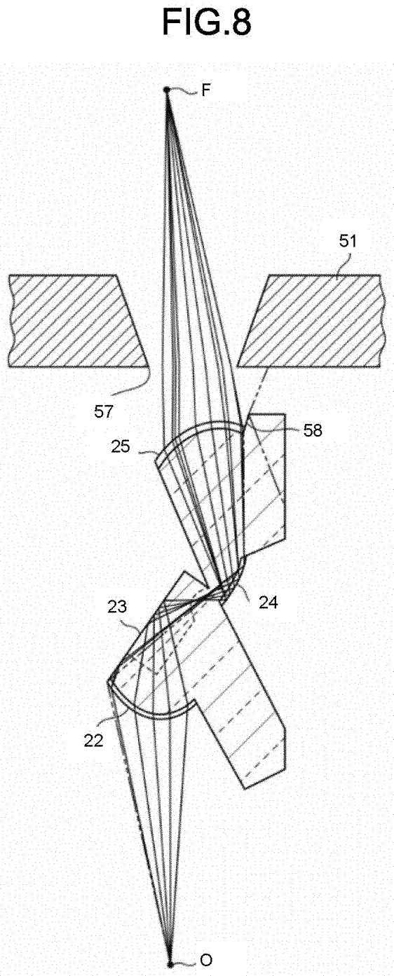

FIG. 8 is cross-sectional view of the lens mirror array according a third embodiment. In FIG. 8, the stray light reflected by the upstream side reflection surface 23 is shielded near the ridge 22a.

In the third embodiment, an inclined surface 58 for selectively totally reflecting the stray light is arranged at a part where the stray light passes near the exit side lens surface 25. As a result, the stray light can be directed to the outside of the slit 57 and bifurcated from other effective light, and it is possible to prevent the failure that the noise light reaches the photoconductive drum 31K. Also in this case, the inclined surface 58 functions as the bifurcation module.

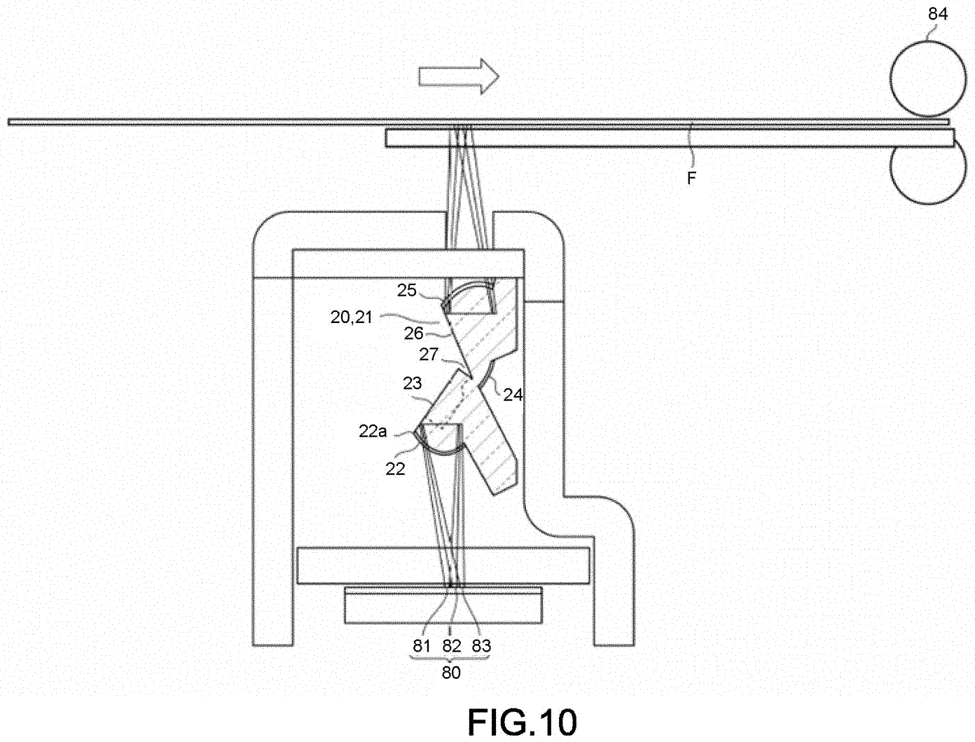

FIG. 10 shows the main portions of an image forming apparatus including the lens mirror array 20 according to the second embodiment. In FIG. 10, the light from the light source 80 having light sources 81, 82 and 83 of RGB is imaged on a photoconductive material F, for example, a silver salt photographic film, conveyed in a direction indicated by the arrow by a conveyance roller 84, the film is exposed and an image is developed by a developing solution by a developing section (not shown).

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A lens mirror array, comprising:
a plurality of optical elements arranged adjacent to each other in a longitudinal direction of the lens mirror array, wherein
each optical element is formed by a plurality of outer surfaces including:
an incident side lens surface through which light enters the optical element,
a reflection surface connected to the incident side lens surface and from which light incident on the incident side lens surface is reflected, and
an exit side lens surface and through which light reflected by the reflection surface exits the optical element, and
the reflection surfaces of each pair of adjacent optical elements form a groove therebetween.

2. The lens mirror array according to claim 1, further comprising:
a light shielding material on an inner surface of the groove.

3. The lens mirror array according to claim 1, wherein
the outer surfaces further include a downstream reflection surface configured to reflect light reflected by the reflection surface.

4. The lens mirror array according to claim 3, wherein
the light reflected by the reflection surface at an edge of the incident side lens surface is led to a bifurcation module adjacent to the exit side lens surface.

5. The lens mirror array according to claim 3, wherein
the outer surfaces further include an inclined surface adjacent to the exit side lens surface.

6. The lens mirror array according to claim 1, wherein
the reflection surface of each of adjacent optical elements is in a same plane.

7. A scanner comprising:
an illuminating device configured to illuminate a document on a document table glass;
a lens mirror array having a plurality of optical elements arranged adjacent to each other in a longitudinal direction of the lens mirror array; and
an image sensor configured to receive reflected light from the document via the lens mirror array and output an image signal, wherein
each optical element is formed by a plurality of outer surfaces including:
an incident side lens surface through which light enters the optical element,
a reflection surface connected to the incident side lens surface and from which light incident on the incident side lens surface is reflected, and
an exit side lens surface through which light reflected by the reflection surface exits the optical element, and
the reflection surfaces of each pair of adjacent optical elements form a groove therebetween.

8. The scanner according to claim 7, further comprising:
an image forming section configured to form an image based on the image signal output from the image sensor.

9. The scanner according to claim 7, further comprising:
a light shielding material on an inner surface of the groove.

10. The scanner according to claim 7, wherein
the outer surfaces further include a downstream reflection surface configured to reflect light reflected by the reflection surface.

11. The scanner according to claim 10, wherein
the light reflected by the reflection surface at an edge of the incident side lens surface is led to a bifurcation module adjacent to the exit side lens surface.

12. The scanner according to claim 10, wherein
the outer surfaces further include an inclined surface adjacent to the exit side lens surface.

13. The scanner according to claim 7, wherein
the reflection surface of each of adjacent optical elements is in a same plane.

14. An image forming apparatus comprising:
a light source configured to emit light based on an image signal;
a lens mirror array having a plurality of optical elements arranged adjacent to each other in a longitudinal direction of the lens mirror array; and
a photosensitive material configured to receive light from the light source via the lens mirror array, wherein
each optical element is formed by a plurality of outer surfaces including:
an incident side lens surface through which light enters the optical element,
a reflection surface connected to the incident side lens surface and from which light incident on the incident side lens surface is reflected, and
an exit side lens surface through which light reflected by the reflection surface exits the optical element, and
the reflection surfaces of each pair of adjacent optical elements form a groove therebetween.

15. The image forming apparatus according to claim 14, further comprising:
a developing device configured to supply toner particles to develop an electrostatic latent image formed in the photosensitive material.

16. The image forming apparatus according to claim 14, further comprising:
a light shielding material on an inner surface of the groove.

17. The image forming apparatus according to claim 14, wherein
the outer surfaces further include a downstream reflection surface configured to reflect light reflected by the reflection surface.

18. The image forming apparatus according to claim 17, wherein
the light reflected by the reflection surface at an edge of the incident side lens surface is led to a bifurcation module adjacent to the exit side lens surface.

19. The image forming apparatus according to claim 17, wherein
the outer surfaces further include an inclined surface adjacent to the exit side lens surface.

20. The image forming apparatus according to claim 14, wherein
the reflection surface of each of adjacent optical elements is in a same plane.
